(19) United States
(12) Patent Application Publication
(10) Pub. No.: US 2025/0280087 A1
(43) Pub. Date: Sep. 4, 2025

(54) IMAGE READING APPARATUS

(71) Applicant: SEIKO EPSON CORPORATION, Tokyo (JP)

(72) Inventor: Masaki NAMIKI, KITAKYUSHU-SHI (JP)

(21) Appl. No.: 19/068,374

(22) Filed: Mar. 3, 2025

(30) Foreign Application Priority Data
Mar. 4, 2024 (JP) 2024-031946

(51) Int. Cl. H04N 1/00

(52) U.S. Cl. CPC H04N 1/00909; H04N 1/00602; H04N 1/00628

(57) ABSTRACT

An image reading apparatus includes a feeding unit being configured to transport a medium along a transport path in a transport direction and including a feeding roller and a separation roller configured to nip the medium with the feeding roller and performs separation of the medium, a transport roller being arranged downstream of the feeding unit in the transport direction and being configured to transport the medium in the transport direction, a reading unit being arranged downstream of the transport roller in the transport direction and being configured to read an image of the medium, and a suction unit including a suction port arranged between the feeding unit and the transport roller in the transport path and being configured to suck a foreign matter in the transport path.

The present application is based on, and claims priority from JP Application Serial Number 2024-031946, filed Mar. 4, 2024, the disclosure of which is hereby incorporated by reference herein in its entirety.

### BACKGROUND

### 1. Technical Field

The present disclosure relates to an image reading apparatus.

### 2. Related Art

Various image reading apparatuses have been used in the related art. The present disclosure relates to an image reading apparatus that reads an image of a medium being transported. For example, WO 2023-089743 discloses a medium transport apparatus including an imaging device that reads an image of a medium being transported and a first accommodation portion that communicates with a first gap portion, wherein the first gap portion is formed at a position upstream of the imaging device in a transport direction of the medium between a second transport roller and an optical frame.

The medium transport apparatus disclosed in WO 2023-089743 is configured so that a foreign matter in a transport path of the medium, such as paper dust adhering to the medium, can be accommodated in the first accommodation portion via the first gap portion. Although a foreign matter in the transport path is pressed by the medium being transported and arrives at the first gap portion, the paper dust is less likely to fall from the upper part of the first gap portion onto the first accommodation portion. This is because a foreign matter, for example, paper dust is light in weight, and is likely to continue adhering to a medium due to static electricity. Thus, the medium is transported to the imaging device while paper dust adheres to the medium, the paper dust adheres to the imaging device, which may lead to degradation of quality of image reading.

### SUMMARY

In order to solve the above-mentioned problem, an image reading apparatus according to the present disclosure includes a feeding unit being configured to transport a medium along a transport path in a transport direction and including a feeding roller and a separation roller configured to nip the medium with the feeding roller and performs separation of the medium, a transport roller being arranged downstream of the feeding unit in the transport direction and being configured to transport the medium in the transport direction, a reading unit being arranged downstream of the transport roller in the transport direction and being configured to read an image of the medium, and a suction unit including a suction port arranged between the feeding unit and the transport roller in the transport path and being configured to suck a foreign matter in the transport path via the suction port.

### BRIEF DESCRIPTION OF THE DRAWINGS

FIG. 1 is a side view of an image reading apparatus of a first embodiment of the present disclosure.

FIG. 2 is a side view of a periphery of a feeding unit of the image reading apparatus in FIG. 1.

FIG. 3 is a partially enlarged view of FIG. 2 for describing a mechanism that generates paper dust.

FIG. 4 is a partially enlarged view of FIG. 2, illustrating a state in which a protrusion portion collects a foreign matter.

FIG. 5 is a partially enlarged view of FIG. 2, illustrating a state in which the foreign matter collected by the protrusion portion moves along a suction path through a gap being a suction port.

FIG. 6 is a perspective view illustrating an internal configuration of a separation roller holder of the image reading apparatus in FIG. 1.

FIG. 7 is a perspective view of the periphery of the feeding unit of the image reading apparatus in FIG. 1.

FIG. 8 is a perspective view illustrating the separation roller holder in the periphery of the suction port in the image reading apparatus in FIG. 1.

FIG. 9 is a perspective view illustrating an internal configuration of a suction unit of the image reading apparatus in FIG. 1.

FIG. 10 is a back cross-sectional view illustrating the internal configuration of the suction unit of the image reading apparatus in FIG. 1.

FIG. 11 is a perspective view illustrating an internal configuration of a suction unit of an image reading apparatus of a second embodiment of the present disclosure.

FIG. 12 is a perspective view illustrating an air blowing unit of the image reading apparatus in FIG. 11.

FIG. 13 is a back cross-sectional view illustrating an internal configuration of the air blowing unit of the image reading apparatus in FIG. 11.

### DESCRIPTION OF EMBODIMENTS

First, the present disclosure is schematically described.

In order to solve the above-mentioned problem, an image reading apparatus according to a first aspect of the present disclosure includes a feeding unit being configured to transport a medium along a transport path in a transport direction and including a feeding roller and a separation roller configured to nip the medium with the feeding roller and performs separation of the medium, a transport roller being arranged downstream of the feeding unit in the transport direction and being configured to transport the medium in the transport direction, a reading unit being arranged downstream of the transport roller in the transport direction and being configured to read an image of the medium, and a suction unit including a suction port arranged between the feeding unit and the transport roller in the transport path and being configured to suck a foreign matter in the transport path via the suction port.

According to the aspect, there is provided the suction unit that includes the suction port arranged between the feeding unit and the transport roller in the transport path and sucks a foreign matter in the transport path via the suction port. Thus, the suction unit sucks a foreign matter in the transport path, and hence adhesion of a foreign matter onto the reading unit can be suppressed.

In an image reading apparatus according to a second aspect of the present disclosure, which is an aspect dependent on the first aspect, the separation roller is arranged below the feeding roller, and the suction unit includes the suction port being arranged on a side of a surface of the medium transported in the transport path, the surface contacting the separation roller, a suction path communicating with the suction port, and a fan configured to suck air in the suction path.

According to the aspect, the separation roller is arranged below the feeding roller, and the suction unit includes the suction port that is arranged on the side of the surface of the medium transported in the transport path, the surface contacting the separation roller. Thus, it is possible to effectively suck a foreign matter present on the side of the surface of the medium that contacts with the separation roller, for example, paper dust generated on a medium when stacked medium rub against each other or paper dust generated on a medium due to contact with the separation roller.

In an image reading apparatus according to a third aspect of the present disclosure, which is an aspect dependent on the second aspect, the suction unit includes, in the suction path, a foreign matter accommodation portion configured to accommodate the foreign matter sucked through the suction port.

According to the aspect, the suction unit includes, in the suction path, the foreign matter accommodation portion configured to accommodate the foreign matter sucked through the suction port. Thus, the foreign matter sucked through the suction port is accommodated in the foreign matter accommodation portion, and diffusion of the foreign matter inside the image reading apparatus can be suppressed.

An image reading apparatus according to a fourth aspect of the present disclosure, which is an aspect dependent on the second or third aspect, includes a separation holder being attachable and removable while supporting the separation roller, wherein the separation roller holder includes an opening portion communicating with the suction path, and at least a part of the suction path is arranged below the separation roller.

According to the aspect, there is provided the separation holder that is attachable and removable while supporting the separation roller, and the separation holder includes the opening portion communicating with the suction path. Thus, for example, a foreign matter such as paper dust falling down from the separation roller can be captured by the separation roller holder, and can be sucked through the opening portion. Further, at least a part of the suction path is arranged below the separation roller. Thus, the apparatus configuration can be efficient, and the size increase of the apparatus can be suppressed.

In an image reading apparatus according to a fifth aspect of the present disclosure, which is an aspect dependent on any one of the second to fourth aspects, a length of the suction port in a width direction intersecting with the transport direction is greater than a length of the separation roller in the width direction.

According to the aspect, the length of the suction port in the width direction is greater than the length of the separation roller in the width direction. With this configuration, a foreign matter can be sucked effectively through the suction port.

In an image reading apparatus according to a sixth aspect of the present disclosure, which is an aspect dependent on any one of the second to fifth aspects, a protrusion portion at a position facing the suction port in the transport path, the protrusion portion contacting the medium being transported in the transport path.

According to the aspect, there is provided the protrusion portion at the position facing the suction port in the transport path, the protrusion portion contacting the medium being transported in the transport path. With this configuration, the protrusion portion can collect a foreign matter present on the side of the surface of the medium that contacts with the feeding roller, for example, paper dust generated on a medium when stacked medium rub against each other or paper dust generated on a medium due to contact with the feeding roller, and the foreign matter can be sucked effectively.

In an image reading apparatus according to a seventh aspect of the present disclosure, which is an aspect dependent on the sixth aspect, a length of the protrusion portion in a width direction intersecting with the transport direction is greater than a length of the feeding roller in the width direction, and is less than the length of the suction port in the width direction.

According to the aspect, the length of the protrusion portion in the width direction is greater than the length of the feeding roller in the width direction, and is less than the length of the suction portion in the width direction. With this configuration, the protrusion portion effectively collects a foreign matter present on the side of the surface of the medium that contacts with the feeding roller, and the foreign matter can be sucked effectively.

In an image reading apparatus according to an eighth aspect of the present disclosure, which is an aspect dependent on any one of the second to seventh aspects, the fan also has a function of supplying an airflow in the transport path, and is configured to generate an airflow along the reading unit in a direction from one end to the other end in a width direction intersecting with the transport direction and move a foreign matter in the reading unit from the one end side to the other end side.

According to the aspect, the fan includes the function of supplying an airflow in the transport path, and is configured to generate an airflow along the reading unit in a direction from the one end to the other end in the width direction and move a foreign matter in the reading unit from the one end side to the other end side. Thus, adhesion of a foreign matter to the reading unit can be suppressed particularly efficiently by utilizing an airflow generated by the fan.

### First Embodiment

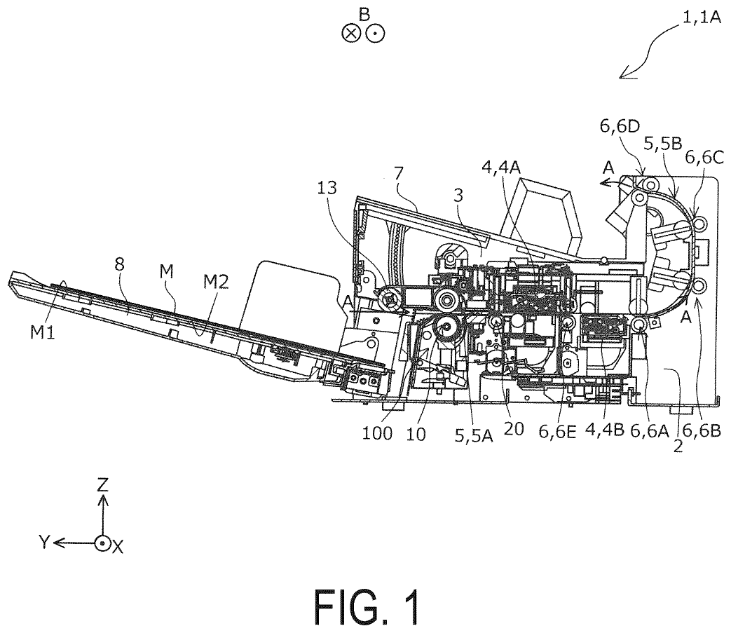

Embodiments of an image reading apparatus 1 according to the present disclosure are described below. First, of the image reading apparatus 1 according to the present disclosure, an image reading apparatus 1A of the first embodiment is described with reference to FIG. 1 to FIG. 10. In the following description, three axes that are orthogonal to each other are referred to as an X axis, a Y axis, and a Z axis, respectively, as illustrated in each of the drawings. Directions indicated by arrows of the three axes (X, Y, and Z) are +directions of the respective directions, and opposite directions are −directions. The Z axis direction corresponds to a vertical direction, that is, a direction in which gravity acts, the +Z direction indicates a vertically upward direction, and the-Z direction indicates a vertically downward direction. The X axis direction and the Y axis direction correspond to the horizontal directions. Of those, the X axis direction corresponds to a width direction B. The +Y direction indicates a forward direction of the device, and the-Y direction indicates a rearward direction of the device. The +X direction indicates a rightward direction of the device, and the-X direction indicates a leftward direction of the device.

An image reading apparatus 1 of the embodiment is a scanner that can read an image on a medium M being a document. Herein, the image indicates what is visually recorded on the medium, and is, for example, a character, a figure, a table, a picture, a photograph, or the like. The medium M is not limited to a sheet, and also includes a card and a booklet. The image reading apparatus 1 is not limited to a scanner, and may be a copying machine, a facsimile machine, or the like.

As illustrated in FIG. 1, the image reading apparatus 1A of the embodiment includes a first reading unit 4A and a second reading unit 4B as the reading unit 4 that reads an image of the medium M. Both the first reading unit 4A and the second reading unit 4B are provided to a transport path 5 of the medium M. The first reading unit 4A can read an image of a first surface M1 of the medium M, and the second reading unit 4B can read an image of a second surface M2 of the medium M. The first reading unit 4A is provided upstream in the transport direction A, and the second reading unit 4B is provided downstream in the transport direction A. However, the configuration is not limited thereto, and the first reading unit 4A and the second reading unit 4B may be arranged to face each other. For example, the reading unit 4 includes a sensor of a contact image sensor (CIS) type, a sensor of a charge coupled device (CCD) type, or the like that extends along the X axis.

The image reading apparatus 1A of the embodiment includes a transport roller pair 20 that transports the medium M along the transport path 5 in the transport direction A, and is provided upstream of the first reading unit 4A in the transport direction A. Further, a plurality of transport roller pairs 6, specifically, the transport roller pair 6E, the transport roller pair 6A, the transport roller pair 6B, the transport roller pair 6C, and the transport roller pair 6D in the order in the transport direction A are provided downstream of the reading unit 4 in the transport direction A. The transport roller pair 6E is provided at a position between the first reading unit 4A and the second reading unit 4B, and the transport roller pair 6A, the transport roller pair 6B, the transport roller pair 6C, and the transport roller pair 6D are provided downstream of the second reading unit 4B in the transport direction A. In this manner, the image reading apparatus 1A of the embodiment includes the plurality of transport roller pairs as a mechanism for transporting the medium M. Alternatively, a transport roller other than a transport roller pair may be used as a mechanism for transporting the medium M.

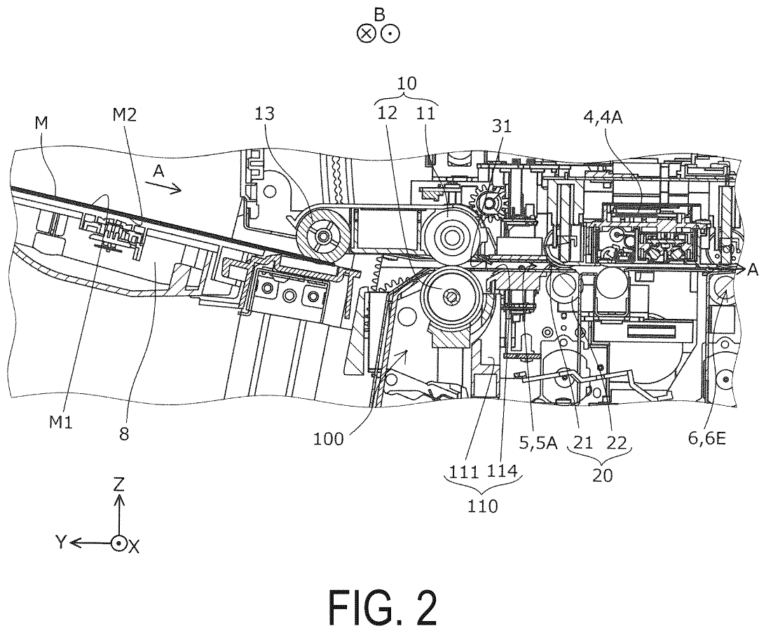

A feeding unit 10 is provided upstream of the transport roller pair 20 in the transport direction A. As illustrated in FIG. 2, the feeding unit 10 is a roller pair configured by a feeding roller 11 and a separation roller 12. The feeding roller 11 is a driving roller that rotates by a driving force of a driving unit (omitted in illustration), and transports the medium M to the transport direction A. The separation roller 12 is a driving roller that is supported by a separation roller holder 100 and rotates by a driving force of a driving unit (omitted in illustration), and is a roller that separates one medium M from a plurality of media M. Details of the separation roller holder 100 are described later.

Herein, the separation roller 12 rotates in a direction of feeding the medium M upstream in the transport direction A. The separation roller 12 includes a torque limiter (omitted in illustration). When a torque exceeding a set value is applied to the torque limiter, the separation roller 12 is driven to rotate in a direction feeding the medium M downstream in the transport direction A. A pick roller 13 is arranged upstream of the separation roller 12. The pick roller 13 is a driving roller that rotates by a driving force of a driving unit (omitted in illustration), and feeds the medium M to the transport direction A.

The transport roller pair 20, and the transport roller pair 6E, the transport roller pair 6A, the transport roller pair 6B, the transport roller pair 60, and the transport roller pair 6D also include driving rollers that rotate by a driving force of a driving unit (omitted in illustration). A driving source for driving rollers of the pick roller 13, the feeding roller 11, and an upper roller 21 being a driving roller of the transport roller pair 20, the transport roller pair 6E, the transport roller pair 6A, the transport roller pair 6B, the transport roller pair 6C, and the transport roller pair 6D are the same power unit, and the power unit is provided to an opening/closing unit 3. Meanwhile, a driving source of the separation roller 12 is provided to a base unit 2.

As illustrated in FIG. 1, the substantially straight transport path 5 from the feeding roller 11 to the transport roller pair 6A is a straight path 5A. As the transport path 5, a curved inversion path 5B is provided downstream of the straight path 5A in the transport direction A, in other words, downstream of the transport roller pair 6A in the transport direction A. The transport roller pair 6B, the transport roller pair 60, and the transport roller pair 6D are provided in the curved inversion path 5B. A discharge reception unit 7 that receives the medium M discharged from the curved inversion path 5B is arranged above the straight path 5A. With this, apparatus size reduction is achieved.

As illustrated in FIG. 1, the medium M being an image reading document is set on a medium setting unit 8. The medium M on the medium setting unit 8 is transported in the transport path 5, and is finally discharged to the discharge reception unit 7. The medium setting unit 8 is configured to move vertically. FIG. 1 illustrates a state in which the medium setting unit 8 is present below, and FIG. 2 illustrates a state in which the medium setting unit 8 is present above. When the medium M set on the medium setting unit 8 is fed in the transport direction A, first, the medium setting unit 8 in a state illustrated in FIG. 1 receives a driving force from a driving source (omitted in illustration) to move upward as illustrated in FIG. 2. Then, the uppermost medium M among the set media M is stopped while contacting the pick roller 13. In this state, the pick roller 13 rotates. As a result, the medium M is transported in the transport direction A, and then the leading edge of the medium M in the transport direction A arrives at a nipping position of the roller pair of the feeding roller 11 and the separation roller 12.

A plurality of media M can be set in a stacking manner on the medium setting unit 8. However, when the media M are stacked, one sheet is separated by the separation roller 12 in a multi-feed state in which a plurality of media M are fed. Then, the one sheet is transported in the transport direction A by the transport roller pair 20, and the reading unit 4 reads an image of the medium M. The medium M after subjected to image reading by the reading unit 4 is fed into the curved inversion path 5B by the transport roller pair 6A, is transported by the transport roller pair 6A, the transport roller pair 6B, the transport roller pair 6C, and the transport roller pair 6D, and is discharged to the discharge reception unit 7 by the transport roller pair 6D that functions as a discharge unit.

As illustrated in FIG. 1, the image reading apparatus 1A is configured by the base unit 2 and the opening/closing unit 3. The opening/closing unit 3 is configured to turn vertically by an opening/closing mechanism (omitted in illustration) to be opened and closed with respect to the base unit 2. The base unit 2 includes the second reading unit 4B, the separation roller 12, a lower roller 22 of the transport roller pair 20, and a driving roller of each of the transport roller pair 6E, the transport roller pair 6A, the transport roller pair 6B, the transport roller pair 6C, and the transport roller pair 6D.

The opening/closing unit 3 includes the first reading unit 4A, the pick roller 13, the feeding roller 11, the upper roller 21 of the transport roller pair 20, and a drive roller of each of the transport roller pair 6E, the transport roller pair 6A, the transport roller pair 6B, the transport roller pair 6C, and the transport roller pair 6D. Further, when the opening/closing unit 3 is closed with respect to the base unit 2, the feeding roller 11 and the separation roller 12, the upper roller 21 and the lower roller 22, and the driving roller and the driven roller of each of the transport roller pair 6E, the transport roller pair 6A, the transport roller pair 6B, the transport roller pair 6, and the transport roller pair 6D are arranged to face each other as illustrated in FIG. 1.

When the opening/closing unit 3 is opened with respect to the base unit 2, the feeding roller 11 and the separation roller 12, the upper roller 21 and the lower roller 22, and the driving roller and the driven roller of each of the transport roller pair 6E, the transport roller pair 6A, the transport roller pair 6B, the transport roller pair 6c, and the transport roller pair 6D are configured not to face each other, which is omitted in illustration. In other words, the facing surfaces of the base unit 2 and the opening/closing unit 3 are exposed, and thus the transport path 5 corresponding to the facing surfaces is accessible for a user.

Next, description is made on details of configurations of the separation roller holder 100 that is a main component of the image reading apparatus 1A of the embodiment and a suction unit 110 that is provided to the separation roller holder 100 and sucks a foreign matter D in the transport path 5. As described above, the image reading apparatus 1A of the embodiment includes
the feeding roller 11, the separation roller 12 that nips the medium M with the feeding roller 11 and separates the medium M, and the feeding unit 10 that transports the medium M along the transport path 5 in the transport direction A. Further, there is provided the transport roller pair 20 that is arranged downstream of the feeding unit 10 in the transport direction A and transports the medium M in the transport direction A. Further, there is provided the reading unit 4 that is arranged downstream of the transport roller pair 20 in the transport direction A and reads an image of the medium M. Further, there is provided the separation roller holder 100 that supports the separation roller 12.

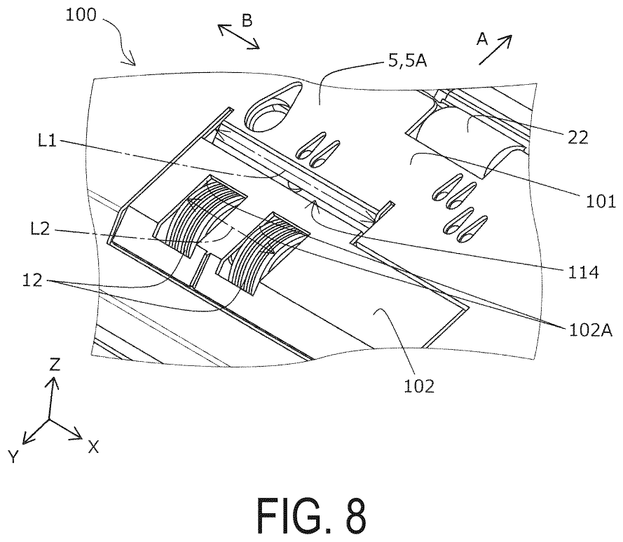

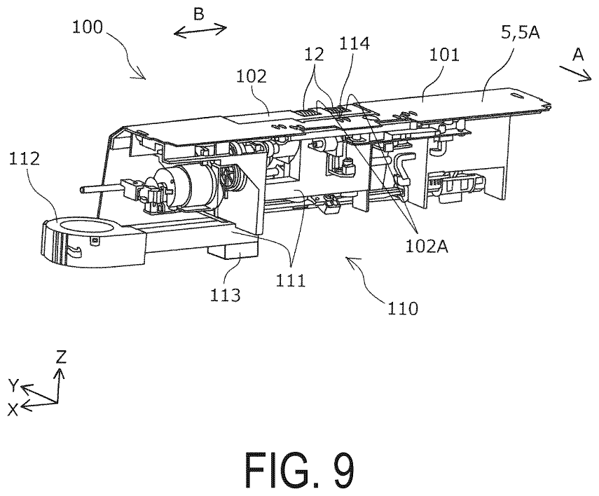

Herein, as described above, the suction unit 110 is provided to the separation roller holder 100 that supports the separation roller 12. As illustrated in FIG. 8 to FIG. 10, the separation roller holder 100 includes an upper cover 101 that forms a part of the straight path 5A of the transport path 5 and a separation roller cover 102 that forms a part of the straight path 5A and includes an opening portion 102A from which the separation roller 12 is exposed. As illustrated in FIG. 8 and FIG. 9, a gap 114 having a slit-like shape is formed between the upper cover 101 and a separation roller cover 102.

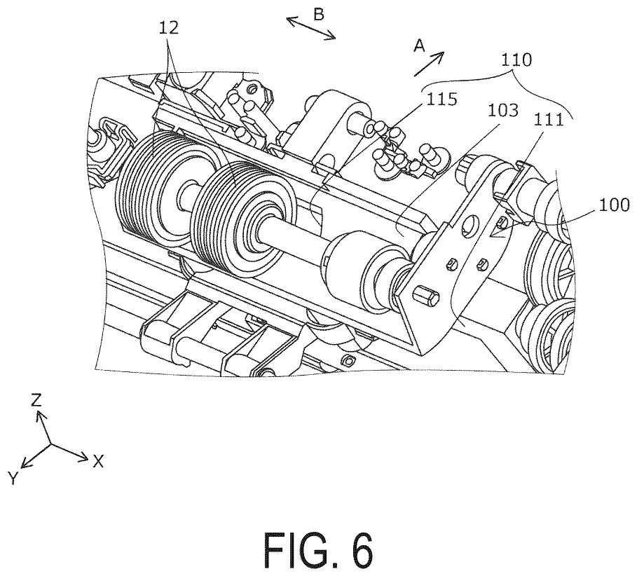

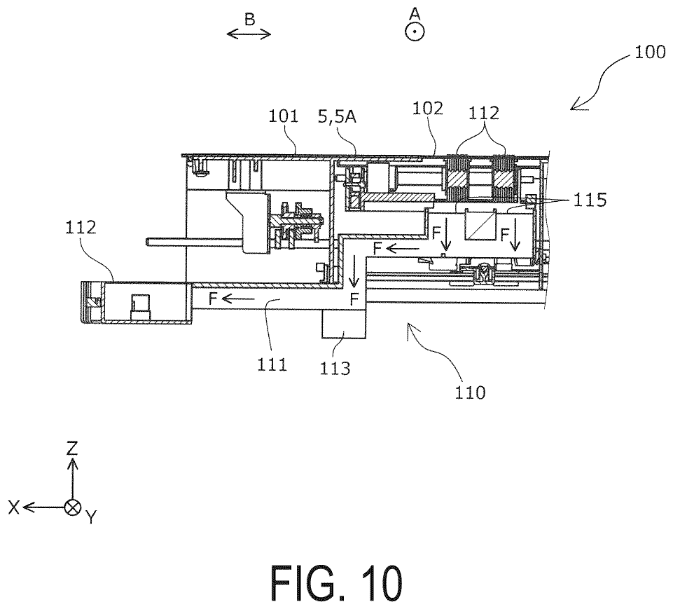

Further, as in FIG. 6 illustrating a state in which the upper cover 101 and the separation roller cover 102 are removed, a separation roller accommodation portion 103 that accommodates the separation roller 12 is provided below the upper cover 101 and the separation roller cover 102, and an opening portion 115 is formed in the separation roller accommodation portion 103. In other words, the gap 114 communicates with the separation roller accommodation portion 103. Further, as illustrated in FIG. 10, the opening portion 115 communicates with a duct 111, and a fan 112 that sucks an air inside the duct 111 is provided at the end of the duct 111, which is opposite to the opening portion 115. Further, as illustrated in FIG. 9 and FIG. 10, a foreign matter accommodation portion 113 is provided between the opening portion 115 and the fan 112 of the duct 111.

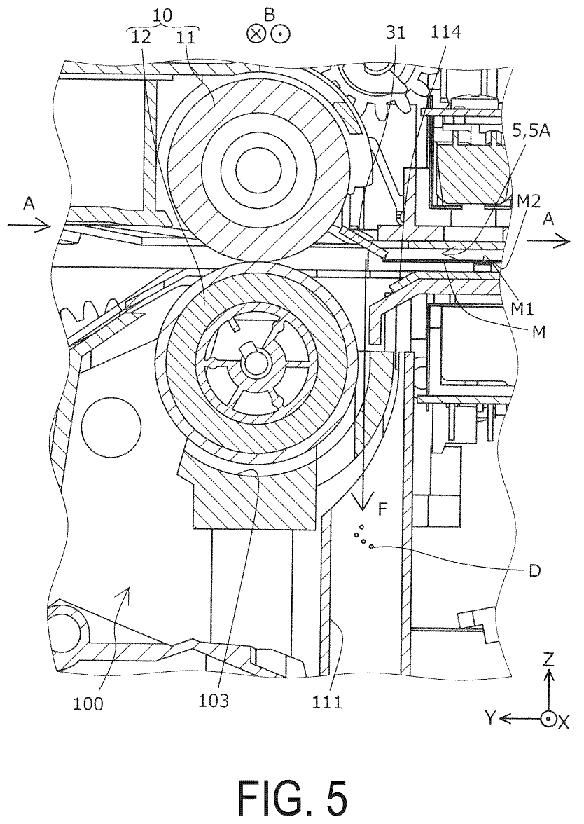

Herein, the gap 114, the separation roller accommodation portion 103, the opening portion 115, the duct 111, the fan 112, and the foreign matter accommodation portion 113 form the suction unit 110. From another viewpoint, the suction unit 110 includes the gap 114 being a suction port between the feeding unit 10 and the transport roller pair 20 being a transport roller in the transport path 5, and is configured to suck the foreign matter D present in the transport path 5 through the gap 114. The image reading apparatus 1A of the embodiment is thus configured. Therefore, the suction unit 110 sucks the foreign matter D in the transport path 5, and hence adhesion of the foreign matter D onto the reading unit 4 can be suppressed. Further, with this, an adhesion amount of the foreign matter D, such as paper dust, onto the reading unit 4 is suppressed, and reading image quality is improved. Note that the arrow F in FIG. 5 and FIG. 10 indicates an airflow direction, in other words, a moving direction of the foreign matter D by the suction unit 110.

Further, as described above, in the image reading apparatus 1A of the embodiment, the opening/closing unit 3 can turn with respect to the base unit 2, and the reading unit 4 can be exposed together with the transport path 5. Thus, when the reading unit 4 is exposed, a user can clean the reading unit 4. As described above, the image reading apparatus 1A of the embodiment is configured so that the foreign matter D is less likely to adhere to the reading unit 4. Thus, the number of times the reading unit 4 is cleaned by a user can be reduced.

Further, in the embodiment, the gap 114 being a suction portion having a slit-like shape is arranged below the transport path 5. However, the configuration is not limited thereto. For example, the suction port may be configured by a plurality of circular holes, square holes, or the like instead of a slit-like shape, and the suction port may be arranged in a transverse direction, an upward direction, or the like of the transport path 5.

As described above, in the image reading apparatus 1A of the embodiment, the separation roller 12 is arranged below the feeding roller 11. Further, the suction unit 110 includes the gap 114 arranged on the lower side being the surface (the second surface M2) side of the medium being transported in the transport path 5, the surface contacting the separation roller 12, the suction path that is formed by the duct 111 and the like and communicates with the gap 114, and the fan 112 that sucks air in the duct 111.

The image reading apparatus 1A of the embodiment is thus configured. Therefore, it is possible to effectively suck the foreign matter D present on the surface (the second surface M2) side of the medium M that contacts with the separation roller 12, for example, paper dust generated on the medium M when the stacked medium M rub against each other or paper dust generated on the medium M due to contact with the separation roller 12. Note that the suction port may be the gap 114 as in the embodiment, and may be configured by an elongated hole or a plurality of holes.

Further, as described above, in the image reading apparatus 1A of the embodiment, the suction unit 110 includes, in the duct 111, the foreign matter accommodation portion 113 that accommodates the foreign matter D sucked through the gap 114. Thus, the foreign matter D sucked through the gap 114 is accommodated in the foreign matter accommodation portion 113, and diffusion of the foreign matter D inside the image reading apparatus 1 can be suppressed.

As described above, in the image reading apparatus 1A of the embodiment, the foreign matter accommodation portion 113 is arranged between the gap 114 being a suction port and the fan 112. Such a configuration may be provided, but the configuration is not limited thereto. For example, the foreign matter accommodation portion 113 may be located behind the fan 112. Further, when the foreign matter accommodation portion 113 is arranged between the gap 114 and the fan 112, a filter or the like may be provided at a position between the foreign matter accommodation portion 113 and the fan 112 or other positions.

Further, as described above, the image reading apparatus 1A of the embodiment includes the separation roller holder 100 that can be attachable and removable while supporting the separation roller 12. The separation roller holder 100 includes the opening portion 115 communicating with the duct 111. At least a part of the duct 111 is arranged below the separation roller 12. Thus, in the image reading apparatus 1A of the embodiment, the foreign matter D such as paper dust falling from the separation roller 12 can be captured in the separation roller accommodation portion 103 of the separation roller holder 100, and can be sucked through the opening portion 115. Further, in the image reading apparatus 1A of the embodiment, at least a part of the duct 111 is arranged below the separation roller 12. Thus, the apparatus configuration can be efficient, and the size increase of the apparatus can be suppressed.

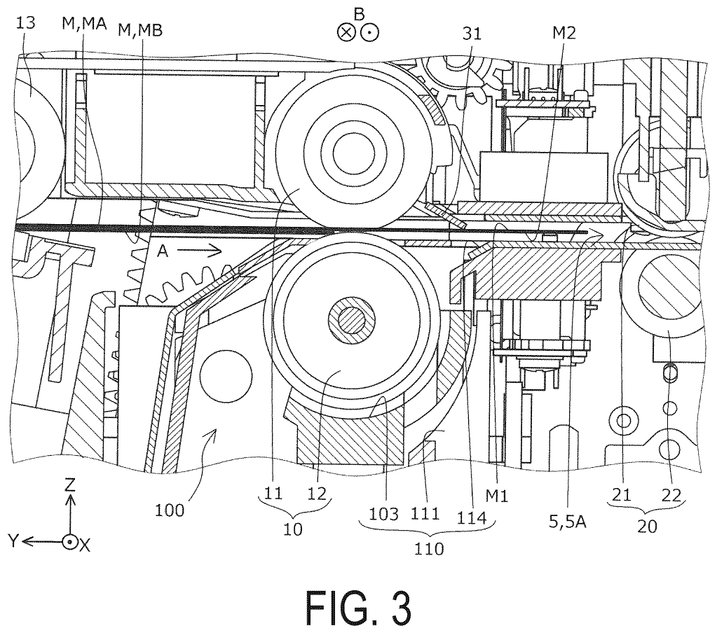

Note that, for example, when a medium MA and a medium MB are stacked vertically as illustrated in FIG. 3, the second surface M2 of the medium MA and the first surface M1 of the medium MB rub against each other. In such a case, paper dust as the foreign matter D may be generated on the second surface M2 of the medium MA and the first surface M1 of the medium MB. Further, for example, when the second surface M2 of the medium M rubs against the separation roller 12, paper dust may be generated on the second surface M2 of the medium M.

Further, as illustrated in FIG. 8, in the image reading apparatus 1A of the embodiment,
a length L1 of the gap 114 being a suction port in the width direction B intersecting with the transport direction A is greater than a length L2 of the separation roller 12 in the width direction B. With this configuration, the foreign matter D can be sucked effectively through the suction port. Note that the length L1 of the suction port indicates an effective width of the suction port, and the length L2 of the separation roller 12 indicates a nipping with by the separation roller 12.

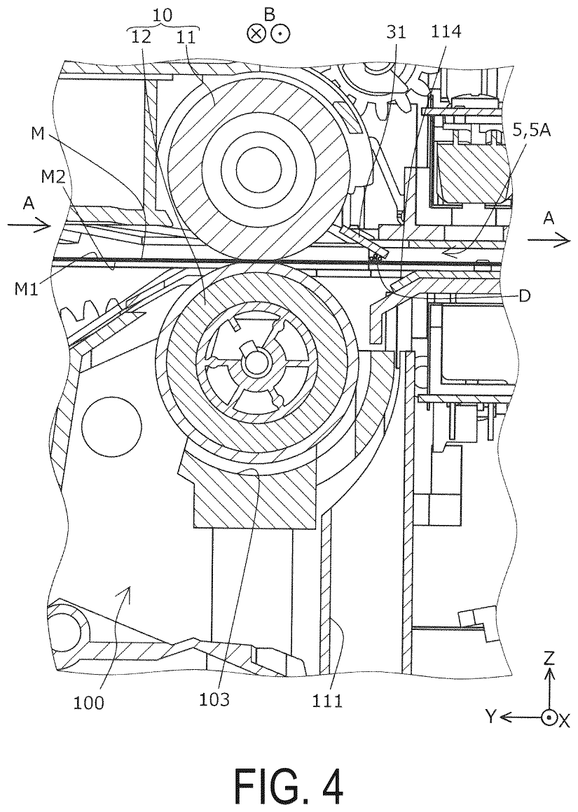

Further, as illustrated in FIG. 2 to FIG. 5 and FIG. 7, the image reading apparatus 1A of the embodiment includes a protrusion portion 31 at a position facing the gap 114 in
the transport path 5. The protrusion portion 31 contacts with the medium M being transported in the transport path 5. As illustrated in FIG. 4, when the medium M is transported while contacting the protrusion portion 31, the protrusion portion 31 can scrape off the foreign matter D on the first surface M1 of the medium M. As illustrated in FIG. 5, when the medium M finished being transported while contacting the protrusion portion 31, the foreign matter D scraped off by the protrusion portion 31 falls down in the direction indicated by the arrow F. The image reading apparatus 1A of the embodiment is thus configured. Therefore, the protrusion portion 31 can collect the foreign matter D present on the surface (the first surface M1) side of the medium M that contacts with the feeding roller 11, for example, paper dust generated on the medium M when the stacked medium M rub against each other or paper dust generated on the medium M due to contact with the feeding roller 11, and the foreign matter D can be sucked effectively.

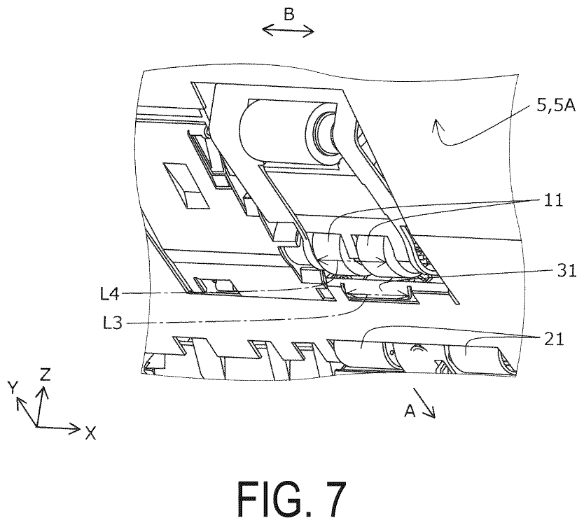

Herein, a length L3 of the protrusion portion 31 in the width direction B, which is illustrated in FIG. 7, is greater than a length L4 of the feeding roller 11 in the width direction B, which is illustrated in FIG. 7. Meanwhile, the length L3 of the protrusion portion 31 in the width direction B is less than the length L1 of the suction port in the width direction B. The image reading apparatus 1A of the embodiment is thus configured. Therefore, the protrusion portion 31 effectively collects the foreign matter D present on the side of the surface (the first surface M1) of the medium M that contacts with the feeding roller 11, and the foreign matter D can be sucked effectively. Note that the length L3 of the protrusion portion 31 indicates a contact width of the protrusion portion 31 with respect to the medium M, and the length L4 of the feeding roller 11 indicates a nipping width by the feeding roller 11.

### Second Embodiment

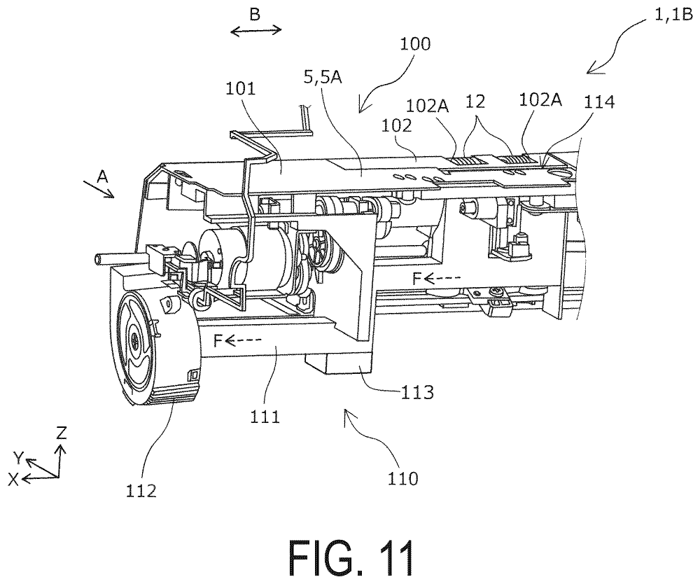

Next, an image reading apparatus 1B of a second embodiment is described with reference to FIG. 11 to FIG. 13. Herein, the image reading apparatus 1B of the embodiment is similar to the image reading apparatus 1A of the first embodiment, except that a cleaning unit, which is described below, is provided, and hence includes features similar to those of the image reading apparatus 1A of the first embodiment. In view of this, in FIG. 11 to FIG. 13, the parts commonly shared with the first embodiment described above are denoted with the same reference symbols, and details thereof are omitted in description.

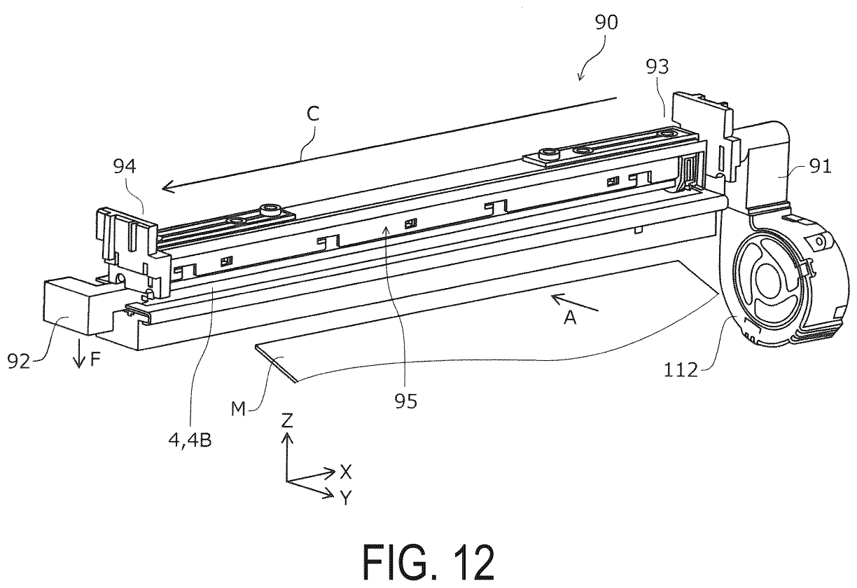

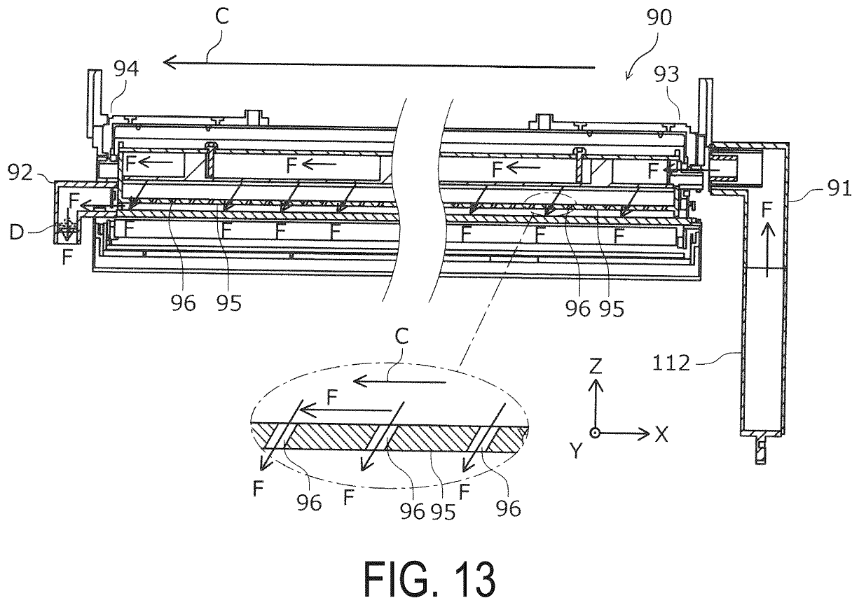

As illustrated in FIG. 11, the image reading apparatus 1B of the embodiment is different from the image reading apparatus 1A of the first embodiment in the configuration of the fan 112. Further, the fan 112 of the image reading apparatus 1B of the embodiment is illustrated in FIG. 12 and FIG. 13, and forms a part of a cleaning unit 90 that can clean the reading unit 4 by blowing air to the reading unit 4. Further, the duct 111 is provided with a filter (omitted in illustration). Note that, in FIG. 11, a coupling portion with a duct 91, which is described later, is omitted in illustration. In FIG. 12 and FIG. 13, a coupling portion with the duct 111 is omitted in illustration.

As illustrated in FIG. 12 and FIG. 13, the cleaning unit 90 includes the duct 91 communicating with the fan 112 and a first accommodation portion 92. The duct 91 is configured to generate an airflow along the transport path 5 in a direction C from one end 93 to the other end 94 in the width direction B intersecting with the transport direction A and move, from the one end 93 to the other end 94, the foreign matter D adhering to the reading unit 4 being a cleaning target. The first accommodation portion 92 is located at the other end 94 of the transport path 5, and is configured to receive and accommodate the foreign matter D moved the direction C in by an airflow.

As illustrated in FIG. 12 and FIG. 13, the duct 91 includes an airflow direction regulation unit 95. The airflow direction regulation unit 95 includes a cylinder portion elongated in the direction C from the one end 93 to the other end 94 and a plurality of air blowout holes 96 provided at a part of the cylinder portion that faces the transport path 5. The plurality of air blowout holes 96 are provided in one row in parallel with the direction C from the one end 93 to the other end 94. Note that the plurality of air blowout holes 96 may be provided in two or more rows.

The air blowout hole 96 is formed so that an airflow blowout direction is inclined toward the other end 94 as indicated by the arrow F. An airflow is jetted obliquely onto the reading unit 4 being a cleaning target. With this, the foreign matter D adhering to the reading unit 4 can be carried, in other words, can be caused to move in the direction C. Note that, in FIG. 12 and FIG. 13, the cleaning target is the second reading unit 4B of the reading unit 4, and, as a matter of course, the cleaning target may be the first reading unit 4A of the reading unit 4.

In this manner, in the image reading apparatus 1B of the embodiment, the fan 112 sucks an air in the suction path such as the duct 111 communicating with the gap 114 being a suction port. The fan 112 includes the function of supplying an airflow in the transport path 5, and is configured to generate an airflow along the reading unit 4 in the direction C from the one end 93 to the other end 94 in the width direction B and move the foreign matter D in the reading unit 4 from the one end 93 side to the other end 94 side. Thus, in the image reading apparatus 1B of the embodiment, adhesion of the foreign matter D to the reading unit 4 can be suppressed particularly efficiently by utilizing an airflow generated by the fan 112.

The present disclosure is not limited to the embodiment described above, and can be realized in various configurations without departing from the spirit of the present disclosure. Further, technical characteristics in the embodiment corresponding to the technical characteristics in each form described in the SUMMARY can be substituted or combined appropriately to solve some or all of the above-described problems, or to achieve some or all of the above-described effects. Furthermore, when the technical characteristics are not described as being essential in the present specification, the technical characteristics can be deleted as appropriate.

What is claimed is:

1. An image reading apparatus comprising:
a feeding unit being configured to transport a medium along a transport path in a transport direction and including:
a feeding roller; and
a separation roller configured to nip the medium with the feeding roller and performs separation of the medium;
a transport roller being arranged downstream of the feeding unit in the transport direction and being configured to transport the medium in the transport direction;
a reading unit being arranged downstream of the transport roller in the transport direction and being configured to read an image of the medium; and
a suction unit including a suction port arranged between the feeding unit and the transport roller in the transport path and being configured to suck a foreign matter in the transport path via the suction port.

2. An image reading apparatus according to claim 1, wherein
the separation roller is arranged below the feeding roller, and
the suction unit includes:
the suction port being arranged on a side of a surface of the medium transported in the transport path, the surface contacting the separation roller;
a suction path communicating with the suction port; and
a fan configured to suck air in the suction path.

3. An image reading apparatus according to claim 2, wherein
the suction unit includes, in the suction path, a foreign matter accommodation portion configured to accommodate the foreign matter sucked through the suction port.

4. An image reading apparatus according to claim 2, comprising:
a separation holder being attachable and removable while supporting the separation roller, wherein
the separation roller holder includes an opening portion communicating with the suction path, and
at least a part of the suction path is arranged below the separation roller.

5. An image reading apparatus according to claim 2, wherein
a length of the suction port in a width direction intersecting with the transport direction is greater than a length of the separation roller in the width direction.

6. An image reading apparatus according to claim 2, comprising:
a protrusion portion at a position facing the suction port in the transport path, the protrusion portion contacting the medium being transported in the transport path.

7. An image reading apparatus according to claim 6, wherein
a length of the protrusion portion in a width direction intersecting with the transport direction is greater than a length of the feeding roller in the width direction, and is less than the length of the suction port in the width direction.

8. An image reading apparatus according to claim 2, wherein
the fan also has a function of supplying an airflow in the transport path, and is configured to generate an airflow along the reading unit in a direction from one end to the other end in a width direction intersecting with the transport direction and move a foreign matter in the reading unit from the one end side to the other end side.
